(19) United States
(12) Patent Application Publication
(10) Pub. No.: US 2026/0143526 A1
(43) Pub. Date: May 21, 2026

(54) DEVICE AND METHOD FOR SWITCHING CHANNEL

(71) Applicant: FRONTSIDE LLC, Seoul (KR)

(72) Inventor: Jeong Soo LEE, Gyeonggi-do (KR)

(21) Appl. No.: 19/119,163

(22) PCT Filed: Sep. 6, 2023
(86) PCT No.: PCT/KR2023/013331

§ 371 Date: Apr. 8, 2025

(30) Foreign Application Priority Data
Oct. 11, 2022 (KR) 10-2022-0129614

(51) Int. Cl. H04W 74/0816; H04L 1/00; H04L 1/1607; H04W 84/12

(52) U.S. Cl. CPC H04W 74/0816; H04L 1/0068; H04L 1/1614; H04W 84/12

(57) ABSTRACT

A device for a wireless local area network determines to switch to a new basic service set (BSS) operating channel. The new BSS operating channel includes at least one punctured 20 MHz subchannel. The device transmits channel switch information to announce the switch to the new BSS operating channel. The channel switch information includes a BSS bandwidth of the new BSS operating channel and a disabled subchannel bitmap indicating the at least one punctured 20 MHz subchannel in the BSS operating channel.

### TECHNICAL FIELD

The present disclosure relates to a wireless local area network (WLAN), and more particularly, to a channel switching method in the WLAN and a device using the same.

### BACKGROUND ART

A wireless local area network (WLAN) may be formed by one or more access points (APs) that provide a shared wireless communication medium for use by a number of client devices also referred to as stations (STAs).

Orthogonal frequency division multiple access (OFDMA) is a multiple access scheme where different subsets of subcarriers are allocated to different users, and this scheme allows simultaneous data transmission to or from one or more users.

A physical layer protocol data unit (PPDU) is a data unit (or data packet) to carry various information in the WLAN. In OFDMA, users are allocated different subsets of subcarriers that can change from one PPDU to the next. Using OFDMA, an AP may allocate different RUs for STAs. The AP can simultaneously transmit various formats of PPDUs to multiple STAs.

Channel switch announcement is a mechanism for an AP to notify connected STAs of its intention to change the operating channel. This allows the STAs to hop to the channel in which the AP is hopping and maintain the connection with the AP.

### DISCLOSURE OF INVENTION

### Technical Problem

The present disclosure provides a method for switching a channel in a wireless local area network.

The present disclosure further provides a device for switching a channel in a wireless local area network.

### Solution to Problem

In an aspect, a method for switching a channel in a wireless local area network is provided. The method performed by an access point (AP) includes determining to switch to a new basic service set (BSS) operating channel, the new BSS operating channel including at least one punctured 20 MHz subchannel, and transmitting channel switch information to announce the switch to the new BSS operating channel, the channel switch information including a BSS bandwidth of the new BSS operating channel and a disabled subchannel bitmap indicating the least one punctured 20 MHz subchannel in the BSS operating channel.

In another aspect, a device for a wireless local area network includes a processor and a memory operatively coupled with the processor and configured to store instructions that, when executed by the processor, cause the device to perform functions. The functions includes determining to switch to a new basic service set (BSS) operating channel, the new BSS operating channel including at least one punctured 20 MHz subchannel, and transmitting channel switch information to announce the switch to the new BSS operating channel, the channel switch information including a BSS bandwidth of the new BSS operating channel and a disabled subchannel bitmap in-dictating the least one punctured 20 MHz subchannel in the BSS operating channel.

### Advantageous Effects of Invention

As new WLAN communication protocols enable enhanced features, new PPDU transmission designs are provided to support signaling regarding features and resource allocations.

### BRIEF DESCRIPTION OF DRAWINGS

FIG. 1 shows a block diagram of an example wireless communication network.

FIG. 2 shows a block diagram of an example wireless communication device.

FIGS. 3 and 4 show various examples of PPDUs usable for wireless communication between an AP and a number of STAs.

FIG. 5 shows an example of wireless channel that includes multiple subchannels.

FIG. 6 shows an example of PPDU transmission.

FIG. 7 shows a procedure for channel switching according to an embodiment of the present disclosure.

FIG. 8 shows an example of Extended Channel Switch Announcement frame format according to an embodiment of the present disclosure.

FIG. 9 shows an example of channel switch information according to an embodiment of the present disclosure.

FIG. 10 shows an example of Extended Channel Switch Announcement frame format according to another embodiment of the present disclosure.

### MODE FOR THE INVENTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

OFDMA is an OFDM-based multiple access scheme where different subsets of subcarriers are allocated to different users, and this scheme allows simultaneous data transmission to or from one or more users. In OFDMA, users are allocated different subsets of subcarriers that can change from one PPDU to the next. Similar to OFDM, OFDMA employs multiple subcarriers, but the subcarriers are divided into several groups where each group is referred to as a resource unit (RU).

A physical layer protocol data unit (PPDU) may span one or more subchannels and may include a preamble portion and a data portion. Signaling refers to control fields or information in the preamble portion that can be used by a wireless communication device to interpret another field or portion of the preamble portion or the data portion of the PPDU. A wireless channel may be formed from multiple subchannels. A subchannel may include a set of subcarriers. Portions of the wireless channel bandwidth can be divided or grouped to form different resource units (RUs). An RU may be a unit for resource allocation and may include one or more subcarriers. Among other things, a preamble portion of a PPDU may include signaling to indicate which RUs are allocated to different devices. Other types of signaling include indicators regarding which subchannels include further signaling or which subchannels may be punctured. There are several formats of PPDUs (and related structures) defined for current wireless communication protocols. As new wireless communication protocols enable enhanced features, new preamble designs are needed support signaling regarding features and resource allocations. Furthermore, it desirable to define a new preamble signaling protocol that can support future wireless communication protocols.

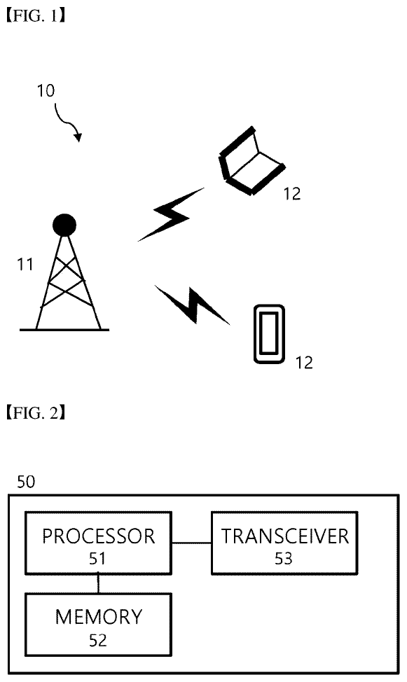

FIG. 1 shows a block diagram of an example wireless communication network.

According to some aspects, the wireless communication network 10 can be an example of a wireless local area network (WLAN) such as a Wi-Fi network (and will hereinafter be referred to as WLAN 10). For example, the WLAN 10 can be a network implementing at least one of the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). The WLAN 10 may include numerous wireless communication devices such as an access point (AP) 11 and multiple stations (STAs) 12. While only one AP 11 is shown, the WLAN network 10 also can include multiple APs.

Each of the STAs 12 also may be referred to as a mobile station (MS), a mobile device, a mobile handset, a wireless handset, an access terminal (AT), a user equipment (UE), a subscriber station (SS), or a subscriber unit, among other possibilities. The STAs 12 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 11 and an associated set of STAs 12 may be referred to as a basic service set (BSS), which is managed by the respective AP 11. The BSS may be identified to users by a service set identifier (SSID), as well as to other devices by a basic service set identifier (BSSID), which may be a medium access control (MAC) address of the AP 11. The AP 11 periodically broadcasts beacon frames (“beacons”) including the BSSID to enable any STAs 12 within wireless range of the AP 11 to “associate” or re-associate with the AP 11 to establish a respective communication link (hereinafter also referred to as a “Wi-Fi link”), or to maintain a communication link, with the AP 11. For example, the beacons can include an identification of a primary channel used by the respective AP 11 as well as a timing synchronization function for establishing or maintaining timing synchronization with the AP 11. The AP 11 may provide access to external networks to various STAs 12 in the WLAN via respective communication link.

To establish a communication link with an AP 11, each of the STAs 12 is configured to perform passive or active scanning operations (“scans”) on frequency channels in one or more frequency bands (for example, the 2.4 GHz, 5 GHz, 6 GHz or 60 GHz bands). To perform passive scanning, a STA 12 listens for beacons, which are transmitted by respective APs 11 at a periodic time interval referred to as the target beacon transmission time (TBTT) (measured in time units (TUs) where one TU may be equal to 1024 microseconds (μs)). To perform active scanning, a STA 12 generates and sequentially transmits probe requests on each channel to be scanned and listens for probe responses from APs 11. Each STA 12 may be configured to identify or select an AP 11 with which to associate based on the scanning information obtained through the passive or active scans, and to perform authentication and association operations to establish a communication link with the selected AP 11. The AP 11 assigns an association identifier (AID) to the STA 12 at the culmination of the association operations, which the AP 11 uses to track the STA 104.

In some cases, STAs 12 may form networks without APs 11 or other equipment other than the STA. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 10. In such implementations, while the STAs 12 may be capable of communicating with each other through the AP 11 using communication links, STAs 12 also can communicate directly with each other via direct wireless links. Additionally, two STAs 12 may communicate via a direct communication link regardless of whether both STAs 12 are associated with and served by the same AP 11. In such an ad hoc system, one or more of the STAs 12 may assume the role filled by the AP 11 in a BSS. Such a STA may be referred to as a group owner (GO) and may coordinate transmissions within the ad hoc network.

The AP 11 and STAs 12 may function and communicate (via the respective communication links) according to the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). These standards define the WLAN radio and baseband protocols for the PHY and medium access control (MAC) layers. The AP 11 and STAs 12 transmit and receive wireless communications (hereinafter also referred to as “Wi-Fi communications”) to and from one another in the form of PPDUs. The AP 11 and STAs 12 in the WLAN 10 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the AP 11 and STAs 12 described herein also may communicate in other frequency bands, such as the 6 GHz band, which may support both licensed and unlicensed communications. The AP 11 and STAs 12 also can be configured to communicate over other frequency bands such as shared licensed frequency bands, where multiple operators may have a license to operate in the same or overlapping frequency band or bands.

Each of the frequency bands may include multiple channels (which may be used as subchannels of a larger bandwidth channel). For example, PPDUs conforming to the IEEE 802.11n, 802.11ac and 802.11ax standard may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels (which may be referred to as subchannels).

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a first portion (or “legacy preamble”) and a second portion (or “non-legacy preamble”). The first portion may be used for packet detection, automatic gain control and channel estimation, among other uses. The first portion also may generally be used to maintain compatibility with legacy devices as well as non-legacy devices. The format of, coding of, and information provided in the second portion of the preamble is based on the particular IEEE 802.11 protocol to be used to transmit the payload.

Uplink (UL) means that the signal (or message or PPDU) is transmitted by a STA to an AP, and downlink (DL) means that the signal (or message or PPDU) is transmitted by the AP to one or more STAs.

FIG. 2 shows a block diagram of an example wireless communication device.

In some implementations, the wireless communication device 50 can be an example of a device for use in a STA such as one of the STAs 12 described above with reference to FIG. 1. In some implementations, the wireless communication device 50 can be an example of a device for use in an AP such as the AP 11 described above with reference to FIG. 1. The wireless communication device 50 is capable of transmitting (or outputting for transmission) and receiving wireless communications (for example, in the form of wireless packets). For example, the wireless communication device can be configured to transmit and receive packets in the form of PPDUs and/or medium access control (MAC) protocol data units (MPDUs) conforming to an IEEE 802.11 wireless communication protocol standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 50 can be, or can include, a chip, system on chip (SoC), chipset, package or device that includes one or more processor 51. The processor 51 can include an intelligent hardware block or device such as, for example, a processing core, a processing block, a central processing unit (CPU), a micro-processor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 51 processes information received through a transceiver 53, and processes information to be output through the transceiver 53 through the wireless medium. For example, the processor 806 may implement a physical (PHY) layer and/or a MAC layer configured to perform various operations related to the generation and transmission of PPDUs, MPDUs, frames or packets.

A memory 52 can include tangible storage media such as random-access memory (RAM) or read-only memory (ROM), or combinations thereof. The memory 808 also can store non-transitory processor- or computer-executable software code containing instructions that, when executed by the processor 51, cause the wireless communication device 50 to perform various operations described herein for wireless communication, including the generation, transmission, reception and interpretation of PPDUs, MPDUs, frames or packets. For example, various functions of components disclosed herein, or various blocks or steps of a method, operation, process or algorithm disclosed herein, can be implemented as one or more modules of one or more computer programs.

The transceiver 53 generally includes at least one radio frequency (RF) transmitter (or “transmitter chain”) for transmitting radio signals and at least one RF receiver (or “receiver chain”) for receiving radio signals. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication device 50 can include, or be coupled with, multiple transmit antennas (each with a corresponding transmit chain) and multiple receive antennas (each with a corresponding receive chain).

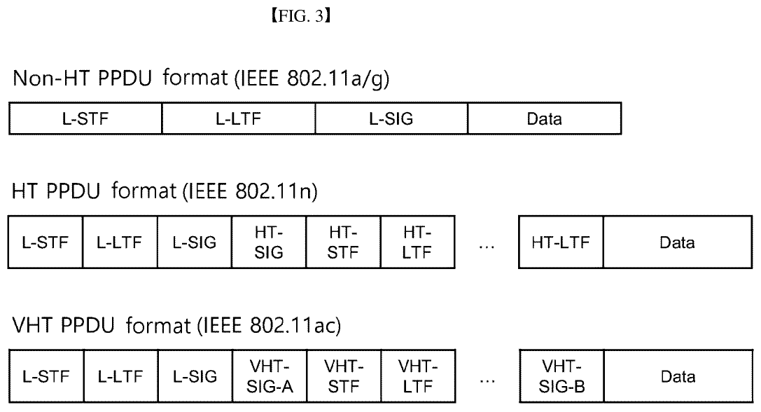

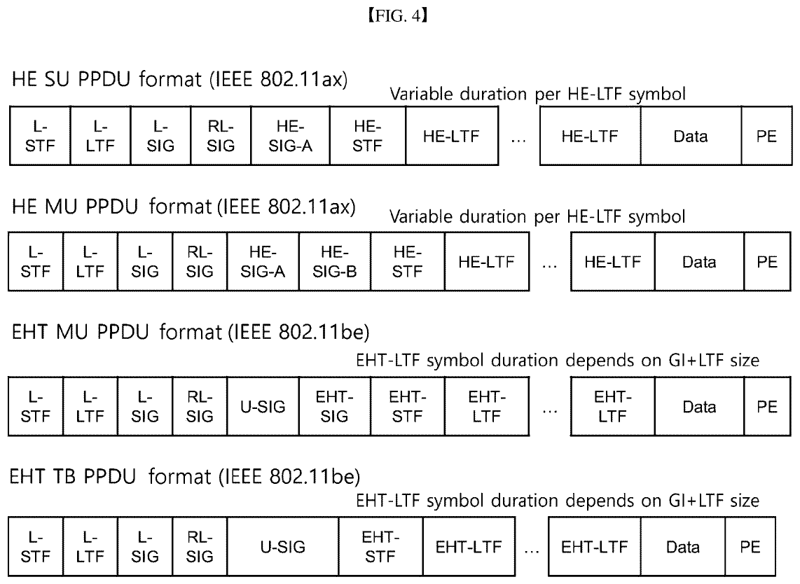

FIGS. 3 and 4 show various examples of PPDUs usable for wireless communication between an AP and a number of STAs.

An PPDU may include a preamble portion and a data portion. ‘Data’ of FIGS. 3-4 denotes the data portion which includes one or more PSDUs and appears after the preamble portion. The data portion may be referred to as a payload.

A non-high-throughput (non-HT) PPDU supporting IEEE 802.11a/g includes a Legacy-Short Training Field (L-STF), a Legacy-Long Training Field (L-LTF), a Legacy-Signal (L-SIG) and a data portion. L-SIG may be called as non-HT Signal. A high-throughput (HT) PPDU supporting IEEE 802.11n includes an L-STF, a HT-SIG, a HT-STF, a HT-LTF and a data portion. A very high throughput (VHT) PPDU supporting IEEE 802.11ac includes an L-STF, L-SIG, a VHT-SIG-A, a VHT-STF, a VHT-LTF, a VHT-SIG-B and a data portion.

A high-efficiency (HE) PPDU supporting IEEE 802.11ax may include an HE single-user (SU) PPDU for SU transmission and an HE multi-user (MU) PPDU for MU transmission. An extremely high throughput (EHT) PPDU supporting IEEE 802.11e may include an EHT MU PPDU for MU transmission and an EHT trigger based (TB) PPDU.

The preamble portion of a PPDU may include a first portion (or “legacy preamble”) and a second portion (or “non-legacy preamble”). The first portion may include L-STF. L-LTF and L-SIG. The second portion may include at least one of HT-SIG, HT-STF, HT-LTF, VHT-SIG-A, VHT-STF, VHT-LTF, VHT-SIG-B, RL-SIG, HE-SIG-A, HE-STF, HE-LTF, HE-SIG-B, EHT-SIG, EHT-STF, EHT-LTF and U-SIG.

The L-STF may be used for frame detection, Automatic Gain Control (AGC), diversity detection, and coarse frequency/time synchronization. The L-LTF may be used for fine frequency/time synchronization and channel estimation. The L-SIG may include information indicating a total length of a corresponding PPDU (or information indicating a transmission time of a PSDU).

The VHT-SIG-A field carries information required to interpret VHT PPDUs. The VHT-STF field is used to improve automatic gain control estimation in a MIMO. The VHT-LTF field provides a means for the receiver to estimate the MIMO channel between the set of constellation mapper outputs and the receive chains. The VHT-SIG-B field may be used for MU transmissions and may contain as signaling information usable by the STAs to decode data received in the DATA field, including, for example, a modulation and coding scheme (MCS) and beamforming information.

The repeated legacy (RL)-SIG field in the HE PPDU and EHT PPDU is a repeat of the L-SIG field and is used to differentiate the HE PPDU and the EHT PPDU from non-HT PPDU, HT PPDU, and VHT PPDU.

HE-SIG-A carries information necessary to interpret HE PPDUs. HE-SIG-A may indicate locations and lengths of HE-SIG-Bs, available channel bandwidths, etc. HE-SIG-B may carry STA-specific scheduling information such as, for example, per-user MCS values and per-user RU allocation information. In the context of DL MU-OFDMA, such information enables the respective STA to identify and decode corresponding RUs in the associated data field.

VHT-STF, HE-STF or EHT-STF may be used to improve an AGC estimation in a MIMO transmission. VHT-LTF, HE-LTF or EHT-LTF may be used to estimate a MIMO channel.

The universal signal field (U-SIG) field of EHT PPDU carries information necessary to interpret EHT PPDUs. The U-SIG may include version independent fields and version dependent fields. The version independent fields may include at least one of a version identifier, a PPDU bandwidth, an indication of whether the PPDU is a UL or a DL PPDU, a BSS color identifying a BSS, and a transmission opportunity (TXOP). The PPDU bandwidth in the version independent fields indicates a transmission bandwidth of the PPDU, for example, 20 MHz, 40 MHz, 80 MHz, 160 MHz or 320 MHz. The version identifier in the version independent fields may indicate a version (and associated format) for the version dependent fields. A PPDU format may determine which other indicators are included in the version dependent fields as well as the version identifier. In some implementations, if the PPDU format indicates that the PPDU is an EHT TB PPDU, then the EHT-SIG may be omitted as shown in EHT TB PPDU of FIG. 4. The version dependent fields of U-SIG may include punctured channel Information and EHT-SIG MCS. The EHT-SIG MCS may Indicate an MCS used for modulating the EHT-SIG. The PPDU bandwidth and the punctured channel information may be referred to collectively as frequency occupation indications. The frequency occupation indications may permit WLAN devices on the wireless channel to determine the utilization of the various parts of the wireless channel. For example, the frequency occupation information may be used to indicate puncturing of some subchannels.

The EHT-SIG field provides additional signaling to the U-SIG field for STAs to interpret an EHT MU PPDU. The EHT-SIG may carry STA-specific scheduling information such as, for example, per-user MCS values and per-user RU allocation information. EHT-SIG includes a common field and at least one STA-specific field (“user specific field”). The common field can indicate RU distributions to multiple STAs, indicate the RU assignments in the frequency domain, indicate which RUs are allocated for MU-MIMO transmissions and which RUs correspond to MU-OFDMA transmissions, and the number of users in allocations. The user specific fields are assigned to particular STAs 104 and may be used to schedule specific RUs and to indicate the scheduling to other WLAN devices.

The EHT-SIG field of a 20 MHz EHT MU PPDU contains one EHT-SIG content channel. For OFDMA transmission and for non-OFDMA transmission to multiple users, the EHT-SIG field of an EHT MU PPDU that is 40 MHz or 80 MHz contains two EHT-SIG content channels. For OFDMA transmission and for non-OFDMA transmission to multiple users, the EHT-SIG field of an MU PPDU that is 160 MH-z or wider contains two EHT-SIG content channels per 80 MHz. The HT-SIG content channels per 80 MHz are allowed to carry different information when EHT MU PPDU bandwidth for OFDMA transmission is wider than 80 MHz. The EHT-SIG field of an EHT MU PPDU sent to a single user and the EHT-SIG field of an EHT sounding NDP contains one EHT-SIG content channel and it is duplicated in each non-punctured 20 MHz when the EHT PPDU is equal to or wider than 40 MHz

For OFDMA transmission, the Common field of an ET-SIG content channel contains information regarding the resource unit allocation such as the RU assignment to be used in the EHT modulated fields of the PPDU, the RUs allocated for MU-MIMO and the number of users in MU-MIMO allocations. In non-OFDMA transmission, the Common field of the EHT-SIG content channel does not contain the RU allocation.

The User Specific fields in the EHT-SIG content channels contains information for all users in the PPDU on how to decode their payload.

A device receiving an PPDU may initially begin or continue its determination of the wireless communication protocol version used to transmit the PPD based on the presence of RL-SIG and the modulation scheme used to modulate the symbols in U-SIG (or HE-SIG-A). In some implementations, the receiving device may initially determine that the wireless communication protocol used to transmit the PPDU is an HE or later version based on the presence of RL-SIG (that is, a determination that the first symbol of the second portion of the preamble is identical to L-SIG) and a determination that both the first symbol and the second symbol following RL-STG are modulated according to a BPSK modulation scheme.

‘UHR’ is used to represent any later (post-EHT) version of a new wireless communication protocol conforming to a future IEEE 802.11 wireless communication protocol standard or other standard, and is for illustration purpose only. ‘UHR’ may be referred to as other terms, for example, Ultra Low Latency (ULL), High Reliability (HR), etc. The UHR PPDU may support future amendments to the IEEE 802.11 wireless communication standard. For example, an UHR PPDU includes L-STF, L-LTF, RL-SIG, U-SIG, UHR-STF, UHR-LTF, a Data field and a packet extension (PE) field. Not all fields are essential and a field may be omitted or added. Names and lengths of the fields in the UHR PPDU are for illustration purpose only.

The techniques in this description are not limited to PPDU formats shown in FIGS. 3-4, but the concepts may apply to any PPDU conforming to IEEE 802.11 wireless communication protocol version.

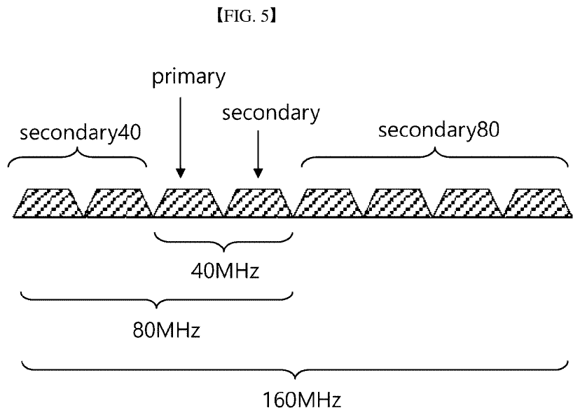

FIG. 5 shows an example of wireless channel that includes multiple subchannels.

A channel map for a frequency band (such as the 2.5 GHz, 5 GHz, 6 GHz frequency band, etc.) may define multiple subchannels. Each subchannel may have a uniform channel width W=20 MHz, but the techniques in this description are not limited to 20 MHz. The channel width W may be smaller than or larger than 20 MHz.

Some WLAN devices are capable of transmitting at higher bandwidths using a wireless channel that is made up of multiple subchannels. When WLAN devices is capable of transmitting at BSS operating channel width is 80 MHz, a group of four subchannels (a primary 20 MHz channel, a secondary 20 MHz channel and a secondary 40 MHz channel) are used. In FIG. 5, BSS operating channel has a bandwidth of 20 MHz, 40 MHz, 80 MHz and 160 MHz. Although depicted as contiguous subchannels in the channel map, in some implementations, the BSS operating channel may contain one or more subchannel which are not adjacent in the channel map. Additionally, larger groups of channels may be used in some implementations. For example, operating channel has a bandwidth of 320 MHz, 640-MHz or larger. The 320 MHz bandwidth may be divided into sixteen 20 MHz subchannels.

The primary channel is the common channel of operation for all STAs that are members of the BSS. The secondary channel is a channel associated with the primary channel used to create a channel wider than the primary channel.

In 40 MHz BSS, the 20 MHz secondary channel adjacent to the primary 20 MHz channel that together form the 40 MHz channel of the 40 MHz BSS.

In 80 MHz BSS, the secondary 20 MHz channel adjacent to the primary 20 MHz channel that together form the primary 40 MHz channel of the 80 MHz BSS. The secondary 40 MHz channel adjacent to the primary 40 MHz channel that together form the 80 MHz channel of the 80 MHz VHT BSS.

In 160 MHz or 80+80 MHz BSS, the secondary 80 MHz channel not including the primary 20 MHz channel, that together with the primary 80 MHz channel including the primary 20 MHz channel form the 160 MHz or 80+80 MHz channel of the 160 MHz or 80+80 MHz BSS.

In 320 MHz BSS, the secondary 160 MHz channel not including the primary 20 MHz channel, which together with the primary 160 MHz channel including the primary 20 MHz channel form the 320 MHz channel of the 320 MHz BSS.

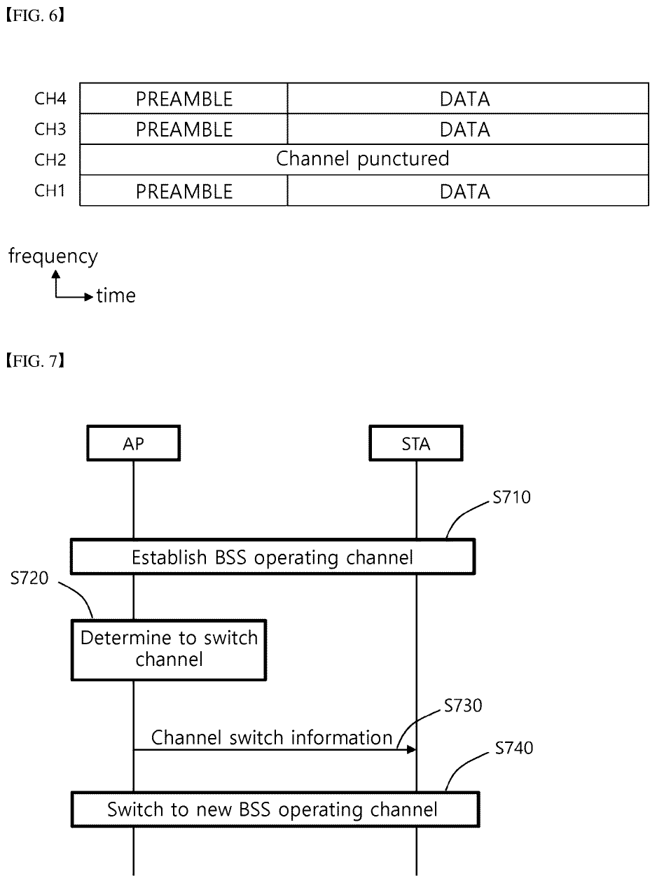

FIG. 6 shows an example of PPDU transmission.

A WLAN device transmits a PPDU by using a four subcbannels CH1, CH2, CH3 and CH4 of 80 MHz operating channel. The PPDU may have any PDDU format shown in FIGS. 3-4. A preamble and data in the PPDU may be duplicated every 20 MHz subchannel. Or only a part of the preamble in the PPDU may be duplicated every 20 MHz subchannel.

The WLAN device would perform a clear channel assessment (CCA) before sending a non-triggered transmission. The CCA is a type of collision avoidance technique. Other types may be referred to as carrier sense, carrier detect, listen-before-talk. CCA is performed by a WLAN device to determine if the wireless communication medium (such as the group of subchannels) is available or busy (by another transmission). If the wireless communication medium is in use, the WLAN device may postpone the transmission until the CCA is performed again and the wireless communication medium is idle by another device.

There may be an incumbent system transmission that occupies part of the second subchannel CH2. Therefore, the wireless channel may be punctured to exclude the second subchannel CH2 from the transmission. Thus, the PPDU is sent only on the first subchannel CH1, the third subchannel CH3 and the fourth subchannel CH4.

The punctured channel information may be indicated in a signal field (for example, HE-SIG-A, U-SIG, or EHT-SIG). The punctured channel information may indicate which channels in the total bandwidth (such as 160 MHz or 320 MHz) are punctured, as well as the puncturing mode, such that the receiving STA knows which channels to process for information and which channels are punctured and thus not available or otherwise not including information for processing by the STA.

Preamble puncturing refers to the transmission of a PPDU in which no signal is present in at least one of the 20 MHz subchannels within the PPDU bandwidth. Preamble puncturing might be the result of the unavailability of 20 MHz subchannel(s) within the PPDU bandwidth, such as a busy channel indicated by the CCA or the setting of the Disabled Subchannel Bitmap field in the EHT Operations element. Preamble puncturing may exist in an EHT MU PPDU transmitted in the DL or the UL and in an EHT TB PPDU transmitted by a non-AP STA in the UL. For an EHT MU PPDU, the U-SIG and the EHT-SIG fields include information on preamble puncturing. The preamble puncturing resolution may be 20 MHz for an EHT MU PPDU using OFDMA transmission for a bandwidth larger than 40 MHz and using non-OFDMA transmission for 80 MHz and 160 MHz PPDU bandwidths. The preamble puncturing resolution may be 40 MHz for an EHT MU PPDU using non-OFDMA transmission for a 320 MHz PPDU bandwidth. Preamble puncturing may not be applied in the primary 20 MHz channel of an EHT MU PPDU.

Hereinafter, the proposed channel switching is described.

FIG. 7 shows a procedure for channel switching according to an embodiment of the present disclosure. An AP may be an EHT AP supporting EHT and a STA may be an EHT STA.

In step S710, the AP can establish an BSS operating channel with the STA. The BSS operating channel can be defined by a bandwidth and a center frequency. The bandwidth of the BSS operating channel may be 20 MHz, 40 MHz, 80 MHz, 160 MHz or 320 MHz. The BSS operating channel may include a plurality of subchannels. The BSS operating channel may include a plurality of 20 MHz subchannels. The BSS operating channel may include at least one punctured 20 MHz subchannel.

The AP can announce a BSS operating channel width that is different from the BSS operating channel width that the AP announces to non-AP STAs if the BSS operating channel width includes at least one punctured 20 MHz subchannel.

In step S720, the AP can determine to switch to a new BSS operating channel. The previous BSS operating channel may be called as a first BSS operating channel and the new BSS operating channel may be called as a second BSS operating channel.

The decision to switch to a channel can be made by the AP. Alternatively, the AP can determine to switch to a channel when the AP receives information for switching to a channel from the STA.

In step S730, the AP transmits channel switch information to announce the switch to the new BSS operating channel. In step S740, the AP and the STA can switch to the new BSS operating channel.

The channel switch information includes information about the new BSS operating channel to be switched. A wide bandwidth channel switch element and/or a channel switch wrapper element can be used as the channel switch information. The channel switch information may be included in a channel switch announcement frame and/or an extended channel switch announcement frame. The AP can inform associated STAs that the AP is moving to the BSS operating channel (for example, a new channel and/or operating class) and maintain the association by advertising the switch using the channel switch information (for example, extended channel switch announcement element in extended channel switch announcement frame) until the intended channel switch time.

The AP may request STAs in the BSS to stop transmissions until the channel switch takes place. If possible, the channel switch can be scheduled so that all STAs in the BSS, including STAs in power save mode, have the opportunity to receive the channel switch information before the switch. The AP may send the extended channel switch announcement frame without performing a backoff, after determining the wireless medium is idle for one PIFS.

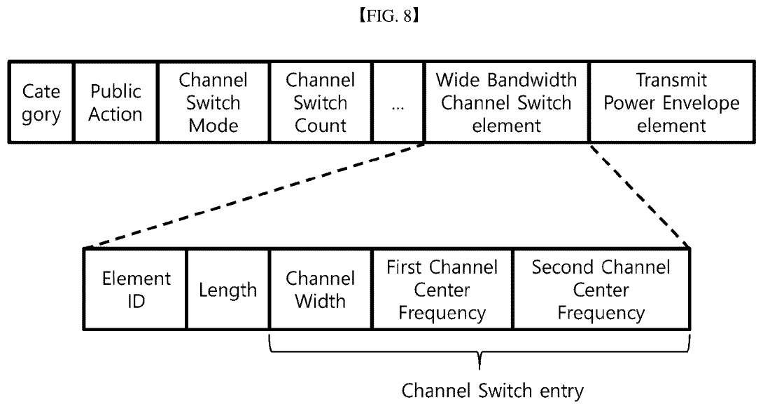

FIG. 8 shows an example of Extended Channel Switch Announcement frame format according to an embodiment of the present disclosure. Names of elements are given only for exemplary purpose and not all elements are essential. This example shows that the wide bandwidth channel switch element is used as channel switch information.

The Channel Switch Mode field indicates any restrictions on transmission until a channel switch. The Channel Switch Count field indicates a intended switch time. The Channel Switch Count field may indicate the number of target beacon transmission times (TBITs) until the AP or STA sending the Channel Switch Count field switches to the new channel. The Channel Switch Count field set to 1 may indicate that the switch occurs immediately before the next TBTT. A Channel Switch Count field set to 0 may indicate that the switch occurs any time after the frame containing the Channel Switch Count field is transmitted.

The Transmit Power Envelope element conveys the local or regulatory maximum transmit powers for various transmission bandwidths or channels within the bandwidth of the new BSS operating channel.

The Wide Bandwidth Channel Switch element is used to indicate a new BSS operating to be switched. The Wide Bandwidth Channel Switch element may include at least one channel switch entry.

The channel switch entry may include a channel width subfield, a first channel center frequency subfield and a second channel center frequency subfield. The channel width subfield indicates a bandwidth of the BSS operating channel. The first channel center frequency subfield and the second channel center frequency subfield are used to indicate a center frequency of the BSS operating channel.

For example, when the Wide Bandwidth Channel Switch element is used to switch to 20 MHz, 40 MHz. 80 MHz or 160 MHz BSS bandwidth, the subfields may be encoded as follows. Encoding values are given only for exemplary purpose.

TABLE 1

| Subfields | Encoding |
|---|---|
| channel | Set to 0 for 20 MHz or 40 MHz BSS bandwidth. |
| width | Set to 1 for 80 MHz, 160 MHz or 80 + 80 MHz BSS |
| | bandwidth. |
| first | For 20, 40, or 80 MHz BSS bandwidth, indicates the channel |
| channel | center frequency index for the 20, 40, or 80 MHz channel on |
| center | which the VHT BSS operates. |
| frequency | For 160 MHz BSS bandwidth and the Channel Width subfield |
| | equal to 1, indicates the channel center frequency index of the |
| | 80 MHz channel segment that contains the primary channel. |
| second | For a 20, 40, or 80 MHz BSS bandwidth, this subfield is set |
| channel | to 0. |
| center | For a 160 MHz BSS bandwidth and the Channel Width |
| frequency | subfield equal to 1, indicates the channel center frequency |
| | index of the 160. |

When the Wide Bandwidth Channel Switch element is used to switch to 320 MHz BSS bandwidth, following options can be proposed.

As a first option, the subfields in the channel switch entry can be utilized, When the Wide Bandwidth Channel Switch element is used to switch to 320 MHz BSS bandwidth, the channel width subfield may be set to a specific value (for example, 4) for 320 MHz EHT BSS bandwidth, the first channel center frequency subfield may indicate the channel center frequency index of the primary 160 MHz channel, and the second channel center frequency subfield may indicate the channel center frequency index of the 320 MHz channel on which the EHT BSS operates.

As a second option, the Wide Bandwidth Channel Switch element may contain more than one channel switch entries to indicate 320 MHz BSS bandwidth switching. When an AP switches to the BSS operating channel having bandwidth of 40 MHz, 80 MHz, or 160 MHz, only one channel switch entry may be included in the Wide Bandwidth Channel Switch element. When an AP switches to the BSS operating channel having 320 MHz BSS bandwidth, in order to support the HT STA, VHT STA, or HE STA that does not recognize 320 MHz BSS bandwidth, the Wide Bandwidth Channel Switch element can include two channel switch entries. The channel width subfield in the first channel switch entry is set to a value that indicates a bandwidth up to 160 MHz (i.e., 40 MHz, 80 MHz, or 160 MHz), the channel width subfield in the second channel switch entry is set to a value that indicates a 320 MHz BSS bandwidth. When an HT STA, VHT STA, or HE STA receives the Wide Bandwidth Channel Switch element, it determines a new BSS operating channel through the first channel switch entry and moves to the new BSS operating channel. When an EHT STA receives the Wide Bandwidth Channel Switch element, the EHT STA can determine the new BSS operating channel through the first channel switch entry and the second channel switch entry (if present) and moves to the new BSS operating channel.

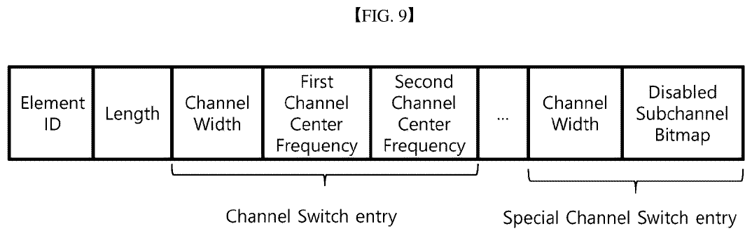

FIG. 9 shows an example of channel switch information according to an embodiment of the present disclosure.

The channel switch information includes at least one channel switch entry and a special channel switch entry. The special channel switch entry may be present in the channel switch information when the new BSS operating channel contains at least one punctured subchannel. The special channel switch entry may indicate a punctured subchannel when the new BSS operating channel to be switched includes the punctured subchannel.

The new BSS operating channel width indicated by the at least one channel switch entry may be the maximum width including the primary channel without covering any punctured 20 MHz subchannels, and the punctured 20 MHz subchannels are indicated by the special channel switch entry.

The special channel switch entry may include a channel width subfield and a Disabled Subchannel Bitmap. The channel width subfield of the special channel switch entry may be set to a value (i.e. 255) to indicate the presence of the Disabled Subchannel Bitmap.

The Disabled Subchannel Bitmap may provide a list of subchannels that are punctured within the BSS bandwidth. The Disabled Subchannel Bitmap may include a plurality of bits. The Disabled Subchannel Bitmap may be a 16-bit bitmap where the lowest numbered bit corresponds to the 20 MHz subchannel that lies within the BSS bandwidth and that has the lowest frequency of the set of all 20 MHz subchannels within the BSS bandwidth. Each successive bit in the bitmap corresponds to the next higher frequency 20 MHz subchannel. A bit in the bitmap and that lies within the BSS bandwidth is set to a first value (i.e. 1) to indicate that the corresponding 20 MHz subchannel is punctured and is set to a second value (i.e. 0) to indicate that the corresponding 20 MHz subchannel is not punctured. A bit in the bitmap that falls outside of the BSS bandwidth may be reserved.

In the conventional WLAN, the STA can know the punctured subchannels after receiving a beacon frame since the beacon frame contains information about the punctured subchannels. The STA needs to wait for receiving any beacon frames when the new BSS operating channel to be switched contains any punctured subchannel. According to the proposed disclosure, information about the punctured subchannels is transmitted during a channel switch announcement procedure. The STA which receives the proposed channel switch information can switch to the new BSS operating channel at the intended switch time.

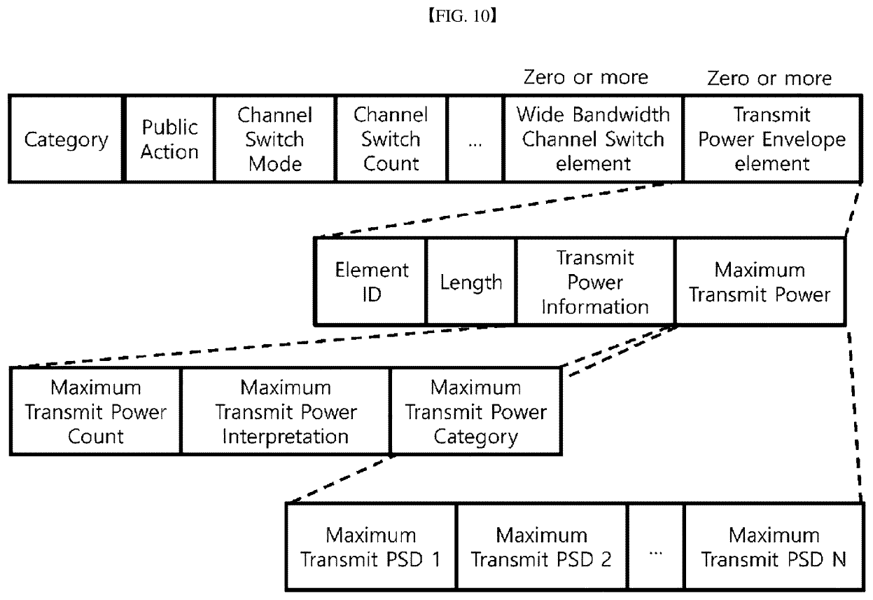

FIG. 10 shows an example of Extended Channel Switch Announcement frame format according to another embodiment of the present disclosure.

For indicating 320 MHz BSS bandwidth switching, more than one Wide Bandwidth Channel Switch elements can be included in the frame (i.e., Channel Switch Announcement frame and/or Extended Channel Switch Announcement frame). TDLS Channel Switch Request frames contains only one Wide Bandwidth Channel Switch element that indicates a channel switching to 320 MHz bandwidth. More than one Wide Bandwidth Channel Switch subelement is included in Channel Switch Wrapper element in Beacon frames or Probe Response frames.

Each Wide Bandwidth Channel Switch element includes one channel switch entry. When an AP switches to a new BSS operating channel having a bandwidth of 40 MHz, 80 MHz, or 160 MHz, only one Wide Bandwidth Channel Switch (sub)element may be included in the Channel Switch Wrapper element, Channel Switch Announcement frame, or Extended Channel Switch Announcement frame. When an AP switches to the new BSS operating channel having 320 MHz BSS bandwidth, in order to support the HT STA, VHT STA, or HE STA that does not recognize 320 MHz BSS bandwidth, two Wide Bandwidth Channel Switch (sub)elements are included. The Channel Width subfield in the first Wide Bandwidth Channel Switch (sub)element is set to a value that indicates a bandwidth up to 160 MHz (i.e., 40 MHz, 80 MHz, or 160 MHz), the Channel Width subfield in the second Wide Bandwidth Channel Switch (sub)element is set to a value that indicates a 320 MHz. An HT STA, VHT STA can determines a new channel and/or operating class through the first Wide Bandwidth Channel Switch (sub)element and moves to the new BSS operating channel. An EHT STA determines the new EHT BSS operating channel through the first Wide Bandwidth Channel Switch (sub)element and the second Wide Bandwidth Channel Switch (sub)element (if present) and moves to the new EHT BSS operating channel.

When the switched BSS operating channel width in the fast Wide Bandwidth Channel Switch (sub)element is the maximum width including the primary channel without covering any punctured 20 MHz subchannels, the punctured 20 MHz subchannels may be indicated by using the Transmit Power Envelope element.

The Transmit Power Envelope element conveys the local or regulatory maximum transmit powers for various transmission bandwidths or channels within the bandwidth of the BSS operating channel. The Transmit Power Envelope element includes a Transmit Power Information field and a Maximum Transmit Power field.

The Maximum Transmit Power Interpretation subfield of the Transmit Power Information field indicates the contents of the Maximum Transmit Power field and interpretation of the Maximum Transmit Power Count field. If the Maximum Transmit Power Interpretation subfield is set a value (i.e. 1 or 3) to indicate a power spectral density (PSD), the Maximum Transmit Power field includes N Maximum Transmit PSD subfields and the Maximum Transmit Power Count subfield is used to determine the value of an integer N.

When the new BSS operating channel to be switched covers any punctured 20 MHz subchannels, the Transmit Power Envelope element is included and the Maximum Transmit PSD X subfields for the punctured 20 MHz subchannels may be set to a specific value (i.e., −128). The Maximum Transmit PSD X subfield is encoded as an 8-bit 2s complement signed integer. The value of −128 indicates that the corresponding 20 MHz channel cannot be used for transmission. The value of +127 indicates that no maximum PSD limit is specified for the corresponding 20 MHz channel. For all other values Y of the subfield (i.e., −127 to +126, inclusive), the maximum transmit PSD in the corresponding 20 MHz channel is Y/2 dBm/MHz (i.e., ranging from −63.5 to +63 dBm/MHz).

As used herein, a phrase referring to “at least one of” or “one or more of” a list of items refers to any combination of those item, including single members. For example, “at least one of: a, b, and c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

While operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some cir-cumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1-12. (canceled)

13. A method for switching a channel in a wireless local area network, the method performed by a station and comprising:
receiving channel switch announcement information from an access point (AP) to announce a switch to a new basic service set (BSS) operating channel, the channel switch announcement information including a first channel switch element indicating a first operating channel and a second channel switch element indicating a second operating channel;
determining the new BSS operating channel based on one of the first channel switch element and the second channel switch element; and
switching to the second operating channel as the new BSS operating channel when the second operating channel in the second channel switch element includes at least one punctured 20 MHz subchannel,
wherein the first channel switch element includes a channel width of the first operating channel,
wherein the second channel switch element includes a channel width of the second operating channel and a disabled subchannel bitmap indicating the at least one punctured 20 MHz subchannel in the second operating channel, and
wherein a channel width of the first operating channel indicates a maximum bandwidth including a primary channel without covering any punctured 20 MHz subchannel indicated in the disabled subchannel bitmap of the second channel switch element.

14. The method of claim 13, wherein the disabled subchannel bitmap includes a 16-bit bitmap where the lowest numbered bit corresponds to a 20 MHz subchannel that lies within the channel width of the second operating channel and that has the lowest frequency of a set of all 20 MHz subchannels within the channel width of the second operating channel, and each successive bit in the 16-bit bitmap corresponds to the next higher frequency 20 MHz subchannel.

15. The method of claim 14, wherein a bit in the 16-bit bitmap is set to one to indicate that the corresponding 20 MHz subchannel is punctured and is set to zero to indicate that the corresponding 20 MHz subchannel is not punctured.

16. The method of claim 14, wherein a BSS bandwidth of the new BSS operating channel is 20 MHz, 40 MHz, 80 MHz, 160 MHz or 320 MHz.

17. The method of claim 14, wherein the channel switch information is transmitted in a channel switch announcement frame or an extended channel switch announcement frame.

18. The method of claim 14, wherein the new BSS operating channel is an extremely high throughput (EHT) BSS operating channel.

19. A device for a wireless local area network, the device comprising:
a processor, and
a memory operatively coupled with the processor and configured to store instructions that, when executed by the processor, cause the device to perform functions comprising:
receiving channel switch announcement information from an access point (AP) to announce a switch to a new basic service set (BSS) operating channel, the channel switch announcement information including a first channel switch element indicating a first operating channel and a second channel switch element indicating a second operating channel;
determining the new BSS operating channel based on one of the first channel switch element and the second channel switch element; and
switching to the second operating channel as the new BSS operating channel when the second operating channel in the second channel switch element includes at least one punctured 20 MHz subchannel,
wherein the first channel switch element includes a channel width of the first operating channel,
wherein the second channel switch element includes a channel width of the second operating channel and a disabled subchannel bitmap indicating the at least one punctured 20 MHz subchannel in the second operating channel, and
wherein a channel width of the first operating channel indicates a maximum bandwidth including a primary channel without covering any punctured 20 MHz subchannel indicated in the disabled subchannel bitmap of the second channel switch element.

20. The device of claim 19, wherein the disabled subchannel bitmap includes a 16-bit bitmap where the lowest numbered bit corresponds to a 20 MHz subchannel that lies within the channel width of the second operating channel and that has the lowest frequency of a set of all 20 MHz subchannels within the channel width of the second operating channel, and each successive bit in the 16-bit bitmap corresponds to the next higher frequency 20 MHz subchannel.

21. The device of claim 20, wherein a bit in the 16-bit bitmap is set to one to indicate that the corresponding 20 MHz subchannel is punctured and is set to zero to indicate that the corresponding 20 MHz subchannel is not punctured.

22. The device of claim 19, wherein a BSS bandwidth of the new BSS operating channel is 20 MHz, 40 MHz, 80 MHz, 160 MHz or 320 MHz.

23. The device of claim 19, wherein the channel switch information is transmitted in a channel switch announcement frame or an extended channel switch announcement frame.

24. The device of claim 19, wherein the new BSS operating channel is an extremely high throughput (EHT) BSS operating channel.
